(19) United States
(12) Patent Application Publication
(10) Pub. No.: US 2020/0226593 A1
(43) Pub. Date: Jul. 16, 2020

(54) METHOD AND SYSTEM OF TRANSFERS OF BANK FUNDS

(71) Applicant: Northern Bank & Trust Company, Woburn, MA (US)

(72) Inventors: Warren BROWN, Concord, MA (US); Laura CORVINO, North Reading, MA (US); Oscar MORENO, Kingston, NH (US); Dan BOUDREAU, Tewksbury, MA (US); Nicholas SALING, Derry, NH (US); Joseph SALING, Derry, NH (US); Donald FORTINI, Beverly, MA (US); Michelle FITZPATRICK, Wakefield, MA (US)

(73) Assignee: Northern Bank & Trust Company, Woburn, MA (US)

(21) Appl. No.: 16/677,263

(22) Filed: Nov. 7, 2019

Related U.S. Application Data
(60) Provisional application No. 62/791,483, filed on Jan. 11, 2019.

(51) Int. Cl. G06Q 20/40; G06Q 40/02; G06Q 20/22

(52) U.S. Cl. CPC G06Q 20/40; G06Q 20/227; G06Q 40/02

(57) ABSTRACT

A method and system of automated funds transfers between accounts that automates the Real Time transfer of funds between a plurality of a Customer's Bank accounts held at one or a plurality of Banks.

### RELATED APPLICATION

This application claims benefit of U.S. Provisional Application Ser. No. 62/791,483, filed Jan. 11, 2019, entitled “Method And System Of Bank Funds Consolidation,” which application is incorporated herein by reference in its entirety.

### FIELD OF THE INVENTION

The present invention relates to a method and system of automating the transfer of bank funds. More particularly, the invention relates to a method and system of automated bank funds transfers involving a Main Bank servicing a Customer who has a plurality of separate bank accounts at the Main Bank and at Banks.

### BACKGROUND OF THE INVENTION

A Main Bank services the banking needs for its Customer who is the owner of Operations requiring separate bank accounts at separate Banks, e.g. a plurality of franchise restaurants. For example, a Customer may own 20 DD Restaurants (“Restaurant”) spread across a specific geographic region, each Restaurant usually being owned by a separate legal entity. In order to manage the cash receipts at each Restaurant, the Customer opens 20 bank accounts at Local Banks with branch locations in close proximity to the Restaurant locations, making it easier for the Restaurant manager to conduct day-to-day banking for the location, including depositing excess cash receipts and obtaining change orders. The Customer, however, wants to maintain its primary operational Banking relationship with Main Bank, perhaps because Main Bank is its primary Bank or because Main Bank provides the loans to fund Customer's growth or because Main Bank provides better service. Thus, the Customer further opens separate Restaurant Operating Accounts at Main Bank for each of the 20 Restaurants in order to more effectively manage the cash flows of each Restaurant. The Customer may further open a Master Account at Main Bank that Customer uses to consolidate excess funds from the individual Restaurant Operating Accounts. The Customer may further maintain multiple loans with the Main Bank and/or another Bank, for which, excess cash must be accumulated in order to make timely monthly payments. Without the present invention, the Customer spends hours every day manually (1) checking balances in the Local Bank Accounts and the Main Bank Operating Accounts; (2) manually initiating funds transfers between the Local Bank Accounts and the Main Bank Operating Accounts, principally to move the excess local receipts up to the Main Bank Operating Accounts; (3) manually initiating funds transfers between the Main Bank Operating Accounts, principally to balance daily/weekly cash flow fluctuations at each Restaurant and avoid overdrafts or returned payments; and (4) manually initiating funds transfers between the Main Bank Operating Account and the Main Bank Master Account, principally to consolidate excess cash flow and to make it available to the Customer.

Under the above example, in addition to the significant manual effort required to manage balances and initiate funds transfers, it may take two to three days for the funds from the Local Bank Accounts to reach the Restaurant Main Bank Operating Accounts. This may result in funds shortages in the Main Bank Operating Accounts and overdraft charges.

Under the above example, the Customer also struggles to: (1) maintain a clear, consolidated understanding of their total funds position across all Bank accounts at all Banks in Real Time; (2) to obtain a consolidated view of all transactions processed across all Bank accounts and to reconcile these transactions with their accounting software or operational reporting; and (3) to determine how often and how much of daily operating funds to set aside in order to meet monthly, quarterly or annual obligations such as loan payments, taxes or insurance. All of the above is time consuming and a substantial expense to the Customer.

Therefore, it would be useful and desirable for a Bank Customer to have the ability to (1) automate the determination of when funds transfers should occur and how much should be transferred between the Local Bank Restaurant Accounts and the Main Bank Restaurant Operating Accounts, including the automation of the execution of the transfers; (2) automate the determination of when funds transfers should occur and how much should be transferred between the Main Bank Operating Accounts to the Main Bank Master Account in the event of excess funds and down from the Main Bank Master Account to the Main Bank Operating Accounts in the event of insufficient funds in a given Operating Account, including the execution of the transfers; (3) automate the determination of when funds transfers should occur and how much should be transferred up or down between multiple tiers of Main Bank Master Accounts; (4) automate the determination of whether and how much of available funds should be set aside in order to accumulate sufficient cash to meet periodic payments, such as monthly loan payments, quarterly tax payments or annual insurance payments; and (5) provide a consolidated, Real Time view of the Customer balances and transaction history from all Bank accounts at all Banks. Current methods and systems in use require, for example, significant manual human intervention to determine the amounts to be transferred and to execute the transfers; fail to execute the transfers in Real Time, leading to potential cash flow shortages at the Local Bank Accounts or the Main Bank Operating Accounts; and require the Customer to maintain a manual record of balances and transactions across Bank accounts and Banks in order to have a consolidated view of balances and transactions.

These and the other shortcomings described above of the present banking methods and systems are addressed by the present invention.

### SUMMARY OF THE INVENTION

The invention provides for a method and system of automated funds transfers for Banks to provide to their Customers who maintain a plurality of Bank accounts at a plurality of Banks to efficiently conduct their day-to-day operations. The terms used herein to describe the invention have the following meanings:

“Bank” means any financial institution that holds deposits on behalf of Customers, including, but not limited to, banks, credit unions, brokerage firms and trust companies, or any other institution that provides a Customer with a User Interface to transfer funds between bank accounts.

“Main Bank” means the primary Bank of a Customer which services the banking needs of the Customer.

“Customer” means the owner (or authorized person) of Operations requiring separate bank accounts at separate Banks, e.g. a plurality of franchise restaurants.

“Operations” means a Customer's business or personal operation requiring separate bank accounts at separate banks including, but not limited to, franchise restaurants; franchise stores, e.g. self-service storage facilities; municipalities; and property managers.

“Local Bank” means a Bank with a location in close proximity to a Customer's Operations, e.g. a Customer's franchise restaurant, thereby making it easier for a restaurant manager to conduct day-to-day banking for the location such as depositing excess cash receipts and obtaining change orders.

“Main Bank Operating Account” or “Operating Account” means the operating bank accounts of a Customer at a Main Bank for each of the Customer's Operations that receive in revenues and payout expenses for each Operation, e.g. the operating bank account for each franchise restaurant of a Customer.

“Main Bank Master Account” or “Master Account” means a bank account of a Customer at a Main Bank that a Customer uses to consolidate excess funds from the individual Operating Accounts or disburse funds down to Operating Accounts needing funds.

“Local Bank Account” means a Customer's deposit bank account at a Local Bank.

“Real Time” means information being shared or a transaction being executed within a range of about a few seconds up to within about the same calendar day.

“User Interface” means a Main Bank computer system where a Customer may log in with a username and/or password to obtain information on the Customer's bank accounts at a Main Bank and a Local Bank, and a Customer may provide Customer Inputs as to the transfer of funds between a plurality of the Customer's bank accounts at one or multiple Banks, e.g. a Main Bank Operating Account and a Local Bank Account.

“Account Connection” means a Customer's use of a Main Bank User Interface to connect to a Local Bank Account through the Main Bank computer network.

“Customer Inputs” means a Customer through a User Interface of a Bank will supply the parameters as to when and how funds should be transferred to or from a Local Bank Account to or from the Main Bank Operating Account or between accounts at a Main Bank or when and how funds should be transferred between a Main Bank bank accounts and bank accounts at another Bank. The Customer Inputs may include, but are not limited to, some or all of: the days of the week funds transfers are requested; the time of day to effectuate the funds transfers; the balance to be retained in each Bank account in the system; the percent of daily receipts to transfer from one Bank account to another Bank account; and the target balance to achieve by a specified date in a Bank account in the case of periodic payments and the transfer of such funds between Bank accounts.

“Transfer Algorithms” means a Main Bank computer system function used in determining whether a transfer of funds should occur and how much funds should be transferred for any given Account Connection.

“Account Integration Interface” means the integration into a Main Bank computer system function for a Customer allowing the Customer to provide log in information to the Main Bank computer system that will allow the computer system to access a Customer's Bank accounts at one or more Local Banks on the Customer's behalf, without the Customer needing to manually log in to the Local Bank each time an account balance or a transaction update is required. Examples of existing providers of Account Integration Interfaces include Plaid, Finicity, Yodlee, and MX.

“External Input Collection Mechanism” means a Main Bank computer system function that periodically connects to external data sources to obtain External Inputs, some or all of which are used by the systems' Transfer Algorithms for a funds transfer.

“External Inputs” means external factors such as an external calendar or clock, an external POS (point of sale) system, a connection to external market data or any other external data source which can be connected to a Main Bank computer system and fed into the Transfer Algorithms to determine whether a funds transfer should occur and how much should be transferred for a given Account Connection.

“Bank Account Input Collection Mechanism” means a Main Bank computer system function that periodically connects the Main Bank software system to the core software of Main Bank to obtain updated balance and transaction histories of a Customer's bank accounts at Main Bank.

“Bank Account Inputs” mean the data collected by the Bank Account Input Collection Mechanism and/or the Account Integration Interface and used by the Transfer Algorithms to determine whether a funds transfer should occur and how much funds should be transferred for a given Account Connection.

“Transfer Execution Mechanism” means a Main Bank computer systems function that takes the data from a plurality of Transfer Algorithms and automatically causes a transfer of funds to take place without requiring human intervention. Transfers may occur as wires, ACH or any other transfer technology that a Main Bank computer system can execute automatically.

“Notification Mechanism” means a Main Bank computer system function that monitors the status of the transfers of funds and/or the balance and/or transaction activity in a Main Bank Operating Account and/or a Local Account and records the information to a database, displays the information in a User Interface and/or notifies a Customer via email, text message or other communications medium of the current status of the funds in the account and the status changes of the funds in the account.

“Integrated Balance/Transaction Display” means a display on a User Interface of a Main Bank which combines together some or all of the balance or transaction information collected from a plurality of a Customer Local Bank Accounts and/or Main Bank Operating Accounts and/or Main Bank Master Accounts and displays the information to the Customer.

A primary object of the invention is to provide a method and system of automated funds transfers that provides a User Interface where the Customer may provide Customer Inputs to direct the transfer of funds between a plurality of Bank accounts at one or multiple Banks. This User Interface allows the Customer to provide the Customer Inputs the system will use to automatically determine when transfers of funds should occur between Bank accounts and how much funds should be transferred. The Customer Inputs are preferably made one time and may be updated as required.

Another primary object of the invention is to provide a method and system of automated funds transfers that leverages Real Time account balance information and transaction details on all connected deposit accounts at a plurality of Banks where the Customer has deposit accounts as inputs to the system's determination of whether transfers of funds should occur and how much funds should be transferred.

Another primary object of the invention is to provide a method and system of automated funds transfers that automatically determines whether a transfer of funds should occur between two or more connected deposit accounts, based on a combination of inputs provided via the User Interface which may include, but are not limited to: Customer Inputs; External Inputs, e.g., day of week, time of day; and Bank Account Inputs collected automatically by the system and method of the invention, e.g., Balance, Transactions, availability.

Another primary object of the invention is to provide a method and system of automated funds transfers for automatically determining the amount of the funds transfers between two or more connected deposit accounts based on a combination of inputs that may include, but are not limited to: Customer Inputs, External Inputs, and Bank Account Inputs.

Another primary object of the invention is to provide a method and system of automated funds transfers for automatically executing the funds transfers between two or more connected deposit accounts in accordance with Customer Inputs, External Inputs and Bank Account Inputs and the system calculations.

Another primary object of the invention is to provide a method and system of automated funds transfers that automatically updates databases and/or the Customer on the status of the automated transfers, e.g. email or text notifications to a Customer; updates to the database of a Customer's Bank accounts so that transfer status can displayed to a Customer through the User Interface or the like.

Another primary object of the invention is to provide a method and system of automated funds transfers for automatically executing second, third or nth tier funds transfers, that is: transfers into or out of a deposit account that itself has already had an automated transfer into or out of it based on a lower tier transfer, based on a combination of inputs that may include, but are not limited to: Customer Inputs, External Inputs, and Bank Account Inputs.

Another primary object of the invention is to provide a method and system of automated funds transfers for presenting the transaction details to a Customer in a consolidated form such as combining transactions from multiple deposit accounts and from multiple financial institutions, e.g. a plurality of a Customer's Local Bank Accounts and Main Bank Operating Accounts.

Another primary object of the invention is to provide a method and system of automated funds transfers for allowing a Customer to tag, flag or otherwise group transactions from two or more deposit accounts at two or more Banks to indicate a commonality between those transactions, e.g. reconciled or not reconciled.

Another primary object of the invention is to provide a method and system of automated funds transfers for allowing a Customer to export the consolidated cash transaction details for use in one or more computer software packages.

The invention is, therefore, directed to a method and system of automated funds transfers comprising providing a Customer with a User Interface that allows the Customer to specify the parameters associated with the transfer of funds between Bank accounts held at one or multiple Banks and owned by the Customer or the Customer's affiliated businesses and the implementation of the Bank funds transfers.

The invention is further directed to a dynamic calculation of a funds transfer amount. Specifically, a Customer does not supply a specific amount to be transferred in a given transaction. Rather, the Customer supplies the parameters for the funds transfer between deposit accounts and the system dynamically, whenever a transfer is determined to be necessary, calculates the amount to be transferred based on the parameters supplied by the Customer and the information about the associated Bank accounts collected by the system.

The invention further involves a funds transfer amount based on a Real Time balance and a Customer's Inputs. Specifically, the invention provides for a method and system that calculates the amount to be transferred based on a Real Time check of the balance available in the source account modified by the inputs provided by the Customer, e.g., a minimum balance to be maintained in the deposit account.

The invention further involves a funds transfer amount based on Real Time balance and pending transactions. Specifically, the invention provides for a method and system that calculates the amount to be transferred based on a Real Time check of the balance available in the source account modified by the amounts of pending transactions on the same source account, e.g. leaving enough funds behind to cover net payments, or pull more than the current balance because pending transactions will result in an increase in the available balance.

The invention further provides for a method and system that automatically calculates the amount of the balance to be transferred, executes the transfer in such a manner that the funds are received in the receiving account within one business day of the transfer being initiated and notifies the Customer of the results of the transfer.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings.

Referring to the drawings:

FIG. 1 is a block diagram illustrating an example of a basic configuration of accounts and connections managed by the invention with three Local Banks and one Main Bank.

FIG. 2 is another block diagram illustrating an example of another configuration of accounts and connections managed by the invention with three Local Banks, one Intermediary Bank and one Main Bank.

FIG. 3 is another block diagram illustrating an example of another configuration of accounts and connections managed by the invention with three Local Banks, and one Main Bank, where the second tier operating accounts are held at the Local Banks.

FIG. 4 is a block diagram illustrating the general flow of inputs and outputs between the various components of the invention.

FIGS. 5A, 5B, 5C, 5D, 5E, 5F, 5G, 5H, 5I(1) and 5I(2) are screen shots of a Main Bank computer system using the invention and illustrating the method and system of the invention.

### DETAILED DESCRIPTION OF THE PREFERRED EMBODIMENTS

The invention is directed to a method and system of automated transfer of funds between multiple Banks or intra-bank fund transfers. The method and system provides a Customer with the ability to access a Main Bank computer system through a login username and/or password to access all of its Bank account information at multiple Banks, including a Main Bank and a Local Bank. The Customer through Customer Inputs may determine the parameters for the transfer of funds between a Main Bank and a Local Bank, a first tier transfer; or a Main Bank Operating Account and a Main Bank Master Account, a second tier transfer; or a Main Bank Master Account and another Main Bank Account, a third tier transfer; or among other Main Bank accounts and other Bank accounts, an nth tier transfer.

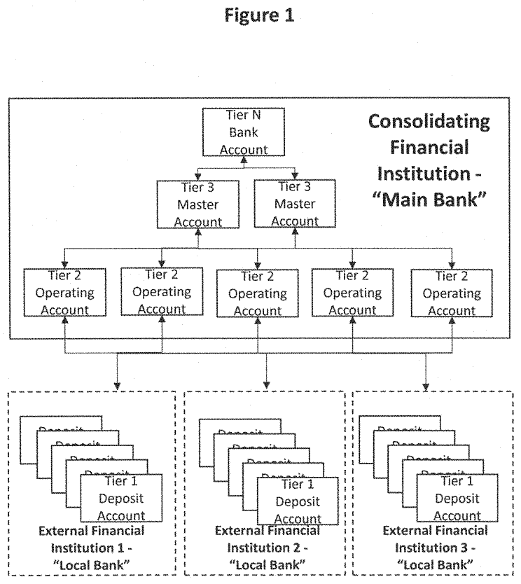

Referring to the drawing, the figures illustrate various nonlimiting embodiments of the invention and which will be discussed in detail below. For example, FIG. 1 is a block diagram illustrating an example of a basic configuration of Bank accounts and connections managed by the invention with three Local Banks and one Main Bank. This system provides for three tiers of transfer, namely, transfer from three Local Banks to the second tier Main Bank Operating Accounts for each Local Bank Account and thereafter to a third tier Main Bank Master Account. In this example, Local Bank 1 may have deposit accounts for one or more Operations of a Customer, e.g. Customers having five restaurants in the vicinity of Local Bank 1. The tier 2 Main Bank Operating Accounts will correspond to each Local Bank Account. The number of tier 3 Master Accounts will be based on the Customer's Operations and decision.

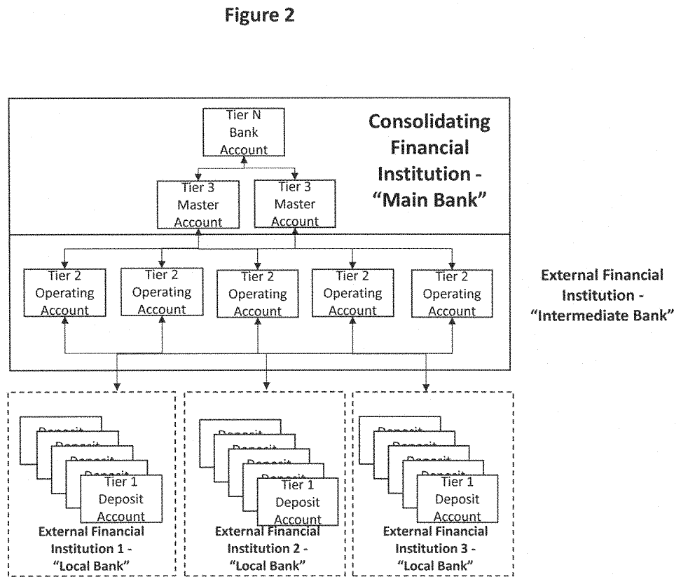

FIG. 2 illustrates an example of another configuration of Bank accounts and connections managed by the invention with three Local Bank, one Intermediary Bank and one Main Bank. In this example, the Customer may have an already formed banking relationship with the Intermediate Bank which manages the Customer Operating Accounts and the Customer may wish to use the services of Main Bank for its Master Account. This example illustrates the scope of the invention, but is not a presently preferred embodiment.

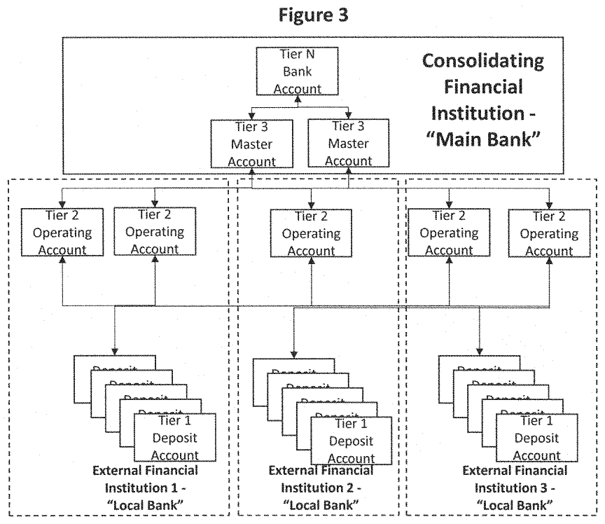

FIG. 3 is another block diagram illustrating an example of another configuration of accounts and connections managed by the invention with three Local Banks, and one Main Bank, where the first tier deposit accounts are held at the Local Banks and the second tier Operating Accounts are also held at the Local Banks. In this example, the Customer may have an already formed banking relationship with the Local Bank which manages the Customer Operating Accounts and the Customer may wish to use the services of Main Bank for its Master Account. This example illustrates the scope of the invention, but is not a presently preferred embodiment.

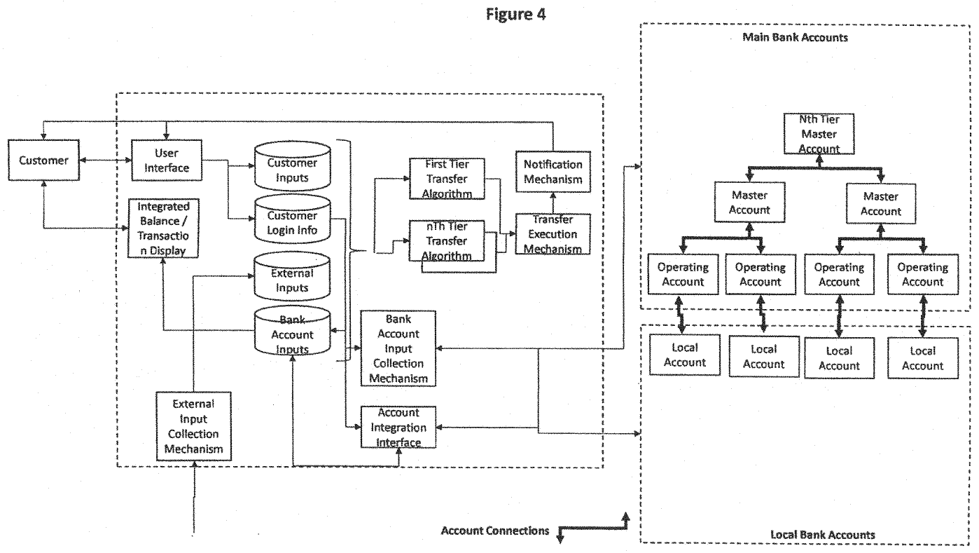

FIG. 4 is a block diagram illustrating the general flow of inputs and outputs between various components of the invention and as described below. Specifically, FIG. 4 illustrates a Customer having four Operations having four Local Bank Accounts, four Main Bank Operating Accounts, and two Main Bank Master Accounts. The system may also have a further nth tier Master Account.

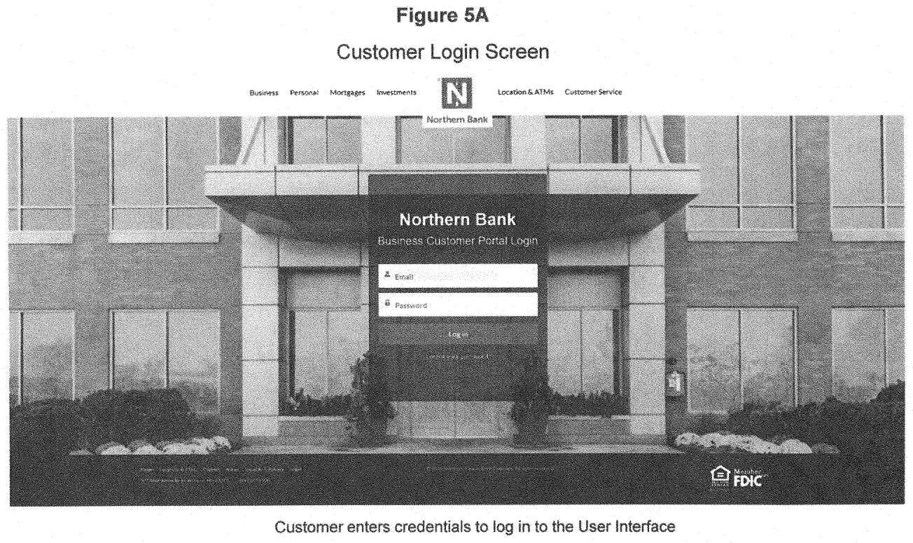

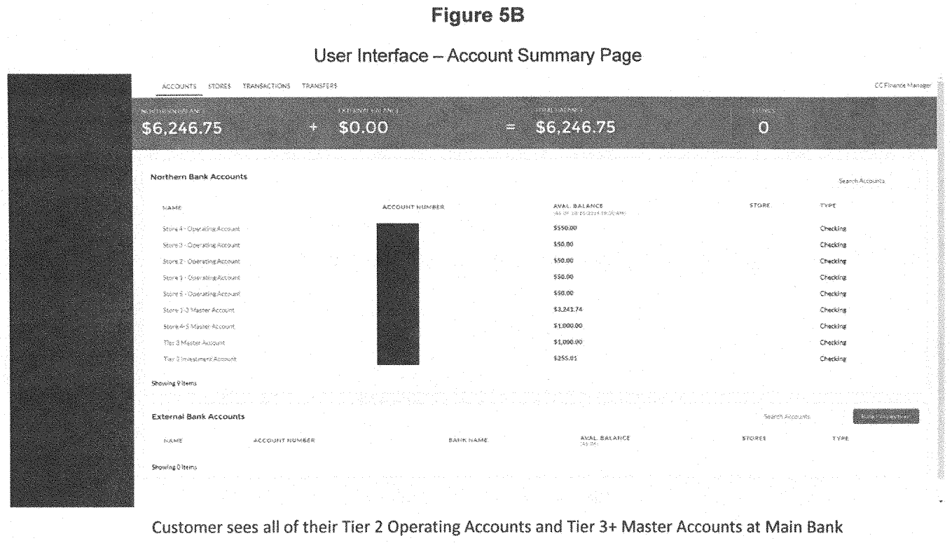

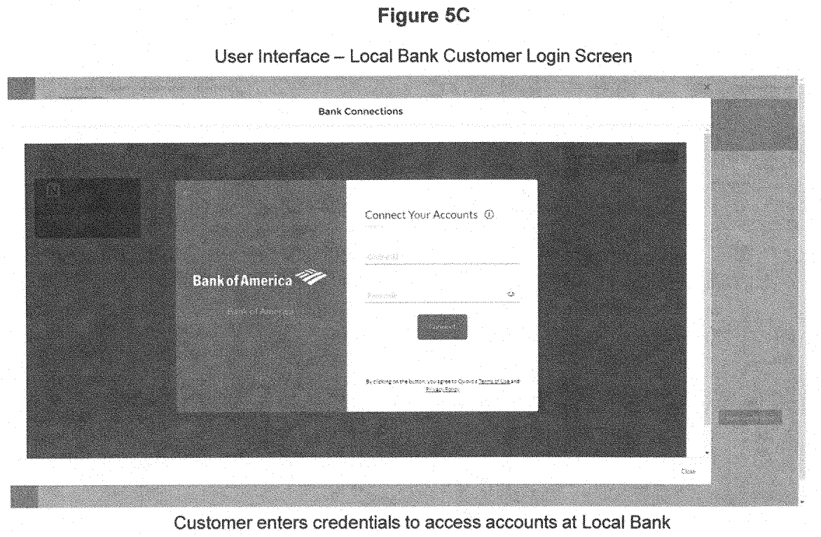

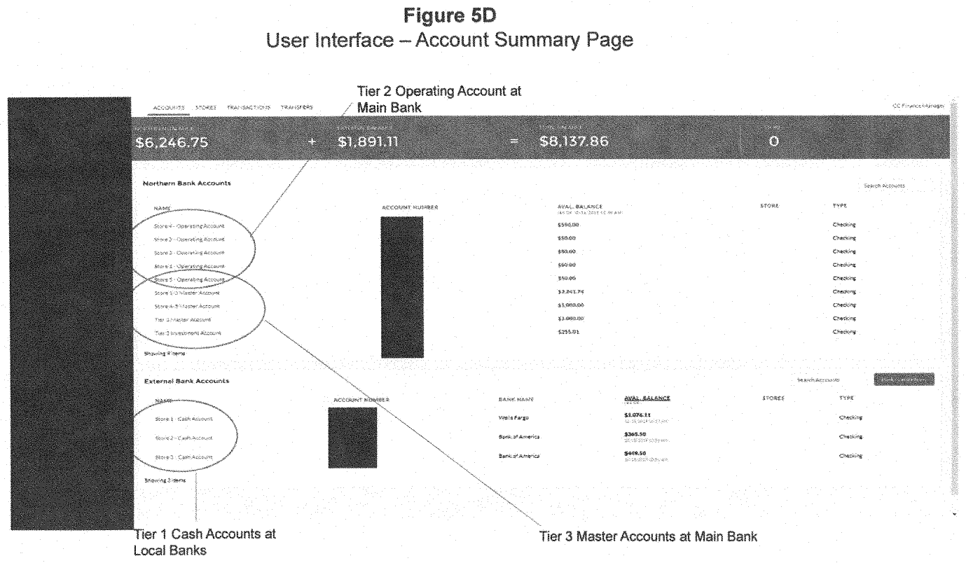

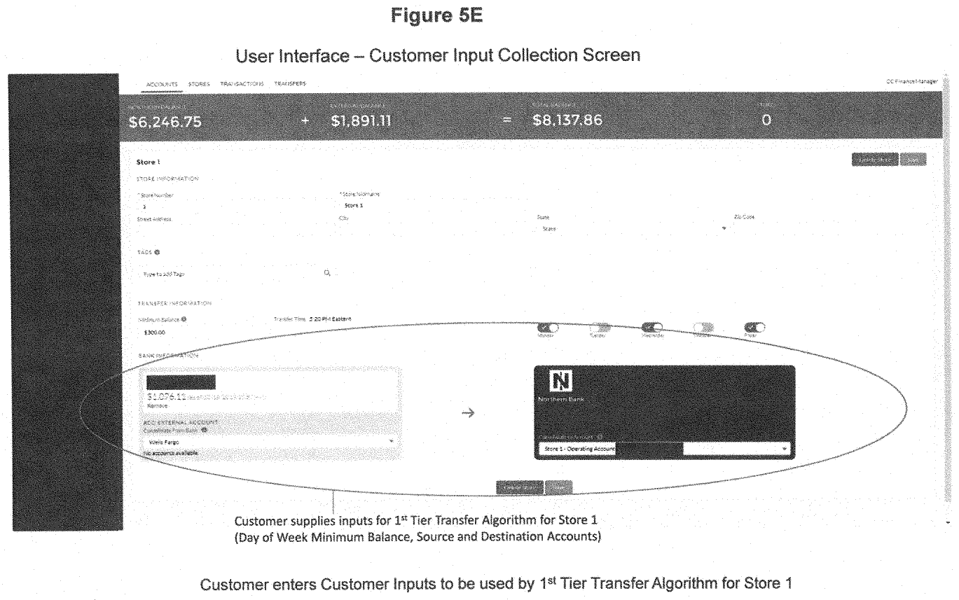

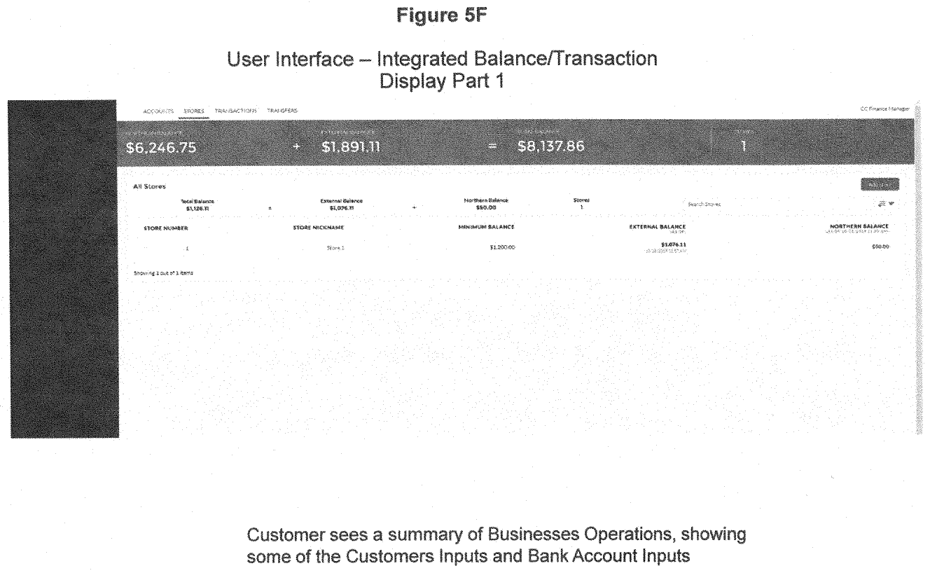

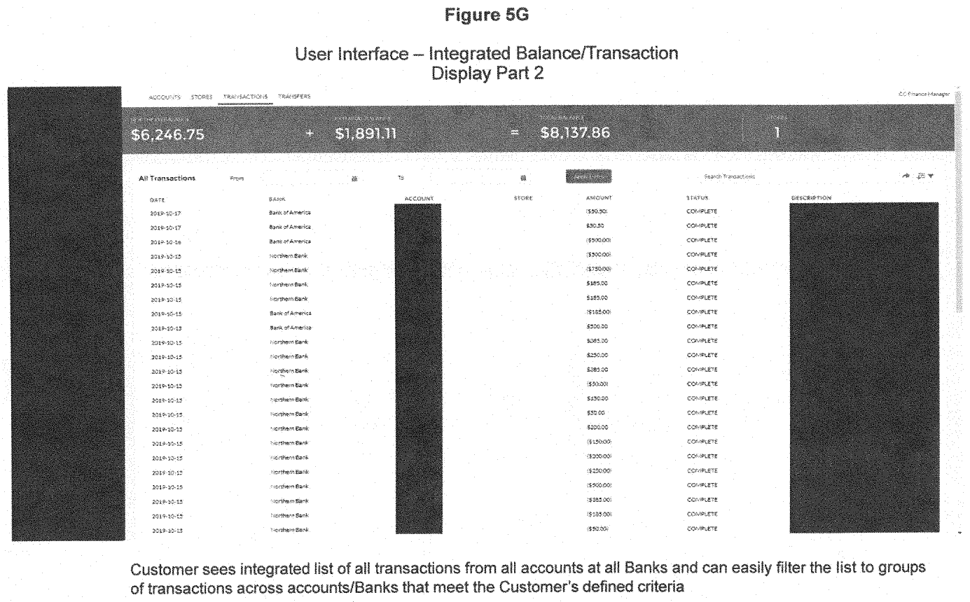

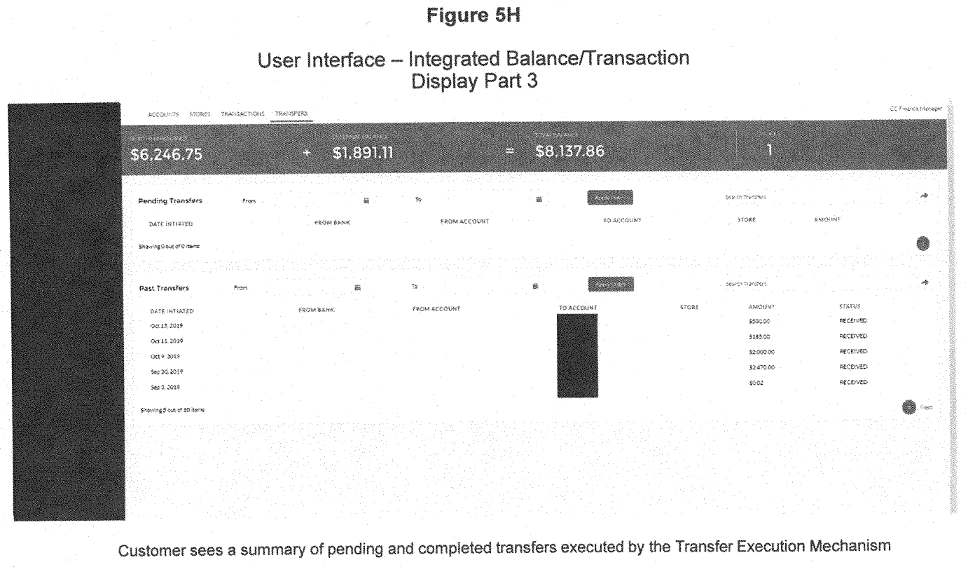

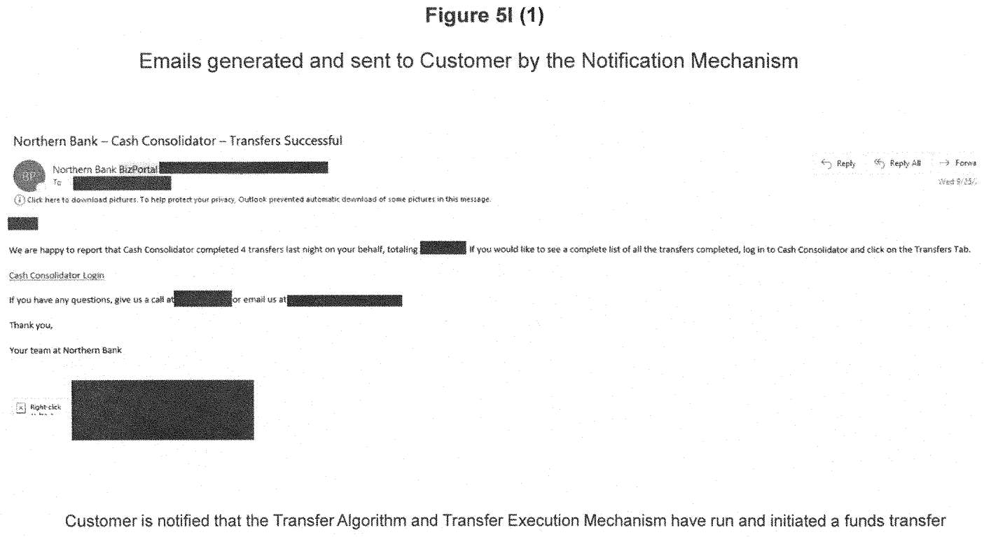

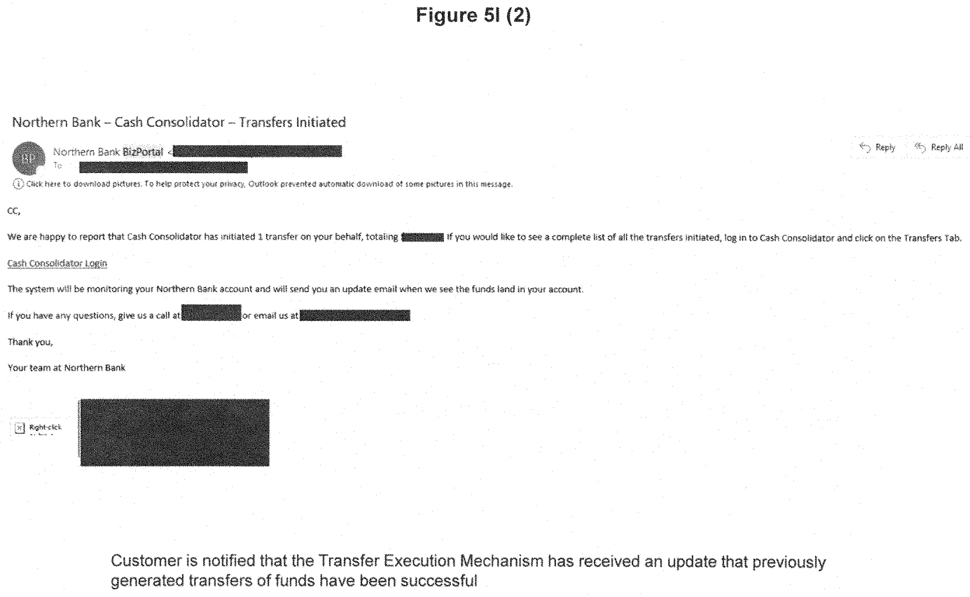

FIGS. 5A, 5B, 5C, 5D, 5E, 5F, 5G, 5H, 5I(1) and 5I(2) are screen shots of a Main Bank computer system using the invention and illustrating the method and system of the invention and as discussed below.

One embodiment of the invention is the simplification and automation of funds transfers for large franchise operators, i.e. a Customer, who have locations spread across a wide geography and conduct a significant percentage of their sales in cash. Each franchise location maintains a Local Bank Account at a Bank with a branch nearby to the franchise location, thereby simplifying deposits of daily cash receipts and daily change orders for the local store manager. The invention provides the Customer with a User Interface through a Main Bank via a computer network that allows the Customer to establish Account Connections between Local Bank Accounts and their associated Main Bank Operating Accounts at the franchise operator's Main Bank. The Customer through the User Interface will supply Customer Inputs as to when and how much funds should be transferred from the Local Bank Account to the Main Bank Operating Account. The User Interface includes a mechanism that obtains the Customer's one-time authorization for the system to access balance and transaction information from the Customer's accounts held at other Banks. The Main Bank computer system automatically calculates the amount to be transferred based on the Customer Inputs, the Bank Account Inputs and any External Inputs; automatically generates the instructions to transfer the funds from one account to another; automatically executes the transfer; once all (n−1) tier transfers have completed, automatically calculates the amount to be transferred for nth tier transfers based on the Customer Inputs, the Bank Account Inputs, the updated balances from the previous transfers and any External Inputs; automatically generates the instructions to transfer the funds associated with nth tier transfers; and automatically reports back on the status of all transfers.

Once the Account Connection is made, the inputs supplied by the Customer and access to the Local Bank Accounts is provided, the system and method of the invention periodically (e.g., hourly, daily, weekly) automatically calculates whether funds should be transferred and how much should be transferred from the Local Bank Account to the Main Bank Operating Account. The system and method of the invention further automatically executes the transfers in Real Time and notifies the franchise operator of the status of the transfers. In this way, the franchise operator is relieved of the manual effort required to get its cash receipts from the Local Bank Account into the Main Bank Operating Accounts from which it pays its bills, etc. This is considered a first tier transfer from the Local Bank Account to the Main Bank Operating Account for a given franchise.

A further embodiment of the invention is multi-tier transfer of funds. The same franchise operator may have tens or hundreds of operating accounts at Main Bank, one for each franchise location. On any given day, a given Main Bank Operating Account may have more funds being deposited than withdrawn or the reverse more funds being withdrawn than deposited. The first-tier consolidation described above simplifies the process of making the funds deposited into Local Bank Accounts available to pay expenses for a single location. Multi-tier consolidation provided by the system and method of the invention further benefits the franchise operator by consolidating excess balances in the individual location Main Bank Operating Accounts, when deposits exceed withdrawals, into a Main Bank Master Account and pushing excess balances down when withdrawals exceed deposits. In this way, the system and method of the invention helps the franchise operator avoid overdrafts or rejected payments in the Local Bank Accounts or Main Bank Operating Accounts and makes excess funds more easily available for investment. Particularly large franchise operators may also establish third, fourth or nth tier funds transfers. For example, consolidating all of the funds from the Operating Accounts of all franchise stores in the city of Atlanta into a second tier Main Bank Master Account and separately consolidating funds from the Operating Accounts of all franchise stores in the city of Savannah in a separate second tier Main Bank Master Account and then further consolidating funds into/from a third tier “Georgia” Main Bank Master Account that has Account Connections to the Atlanta and Savannah Master accounts.

A further embodiment of the invention may apply the same method and system to simplify the franchise operator's ability to accumulate sufficient cash to make on-time loan and tax payments. The operator may need to have a specified amount of funds available on a specific future day or may need to set aside a certain percentage of their revenues. By supplying these and potentially other parameters into the User Interface, the system and method of the invention may at least daily evaluate the volume of incoming deposits and the days and amount to target remaining to determine what amount of a day's incoming deposits to transfer to a loan or tax repayment account.

Further embodiments of the invention may apply the same method and system to simplify the banking activities and reduce cost of companies in other industries, including but not limited to: municipalities that maintain separate Bank Accounts at some or all of the Banks operating in their city or town; self-storage facility operators that maintain locations across a broad geographic area, each of which, for operational purposes, requires a Local Bank Account; property managers that have properties spread across a broad geographic area, each of which, for operational purposes, requires a Local Bank Account, or similarly situated businesses.

The method and system of the invention may comprise the following. There is a Main Bank computer system comprising hardware and software which interfaces between a plurality of the Customer's Main Bank Operating Accounts, a plurality of the Customer Main Bank Master Accounts and a plurality of the Customer's Local Bank Accounts. The computer system provides a User Interface where the Customer provides Customer Inputs to the Main Bank. These Customer Inputs, among other things, establish Account Connections between two Bank accounts at either the Local Bank or the Main Bank; and establish parameters that the computer system's Transfer Algorithms will use in determining whether a transfer should occur and how much should be transferred for any given Account Connection. These inputs may also include the order in which an Account Connection should be processed relative to other Account Connections, i.e. which Account Connections are “First Tier” transfers that process first and which are second tier, third tier or nth tier transfers that process in that order. As stated and defined above, the Customer Inputs may include, but are not limited to, days of the week cash transfers are requested, the cash balance to be retained in each account in the system, the accounts to pull cash from and send cash to, the time of day to effectuate the cash transfers, etc.

The computer system User Interface also provides the Customer the ability to provide login information that will allow the computer system to access the Customer's accounts at the plurality of Local Banks on the Customer's behalf, without the Customer needing to manually login each time a balance or transaction update is required, namely, the “Account Integration Interface.” The Account Integration Interface may be provided by a third party company, such as Plaid, Quovo, Finicity or others, or it may be developed by Main Bank itself.

The Customer Inputs are loaded into a computer software program provided by the Main Bank and which software program will implement the Customer's Inputs.

The Main Bank computer system includes a Bank Account Input Collection mechanism that periodically connects to the software systems of Main Bank to obtain updated balance and transaction histories from each of the accounts and/or loans. This balance and transaction history data combined with the balance and transaction history data from Local Bank Accounts provided by the Account Integration Interface become the “Bank Account Inputs” some or all of which are used by the system's Transfer Algorithms to determine whether a funds transfer should occur and how much should be transferred for a given Account Connection.

The Main Bank computer system includes an External Input Collection Mechanism that periodically connects to external data sources to obtain External Inputs, some or all of which are used by the system's Transfer Algorithms to determine whether a funds transfer should occur and how much should be transferred for a given Account Connection. A simple example of an External Input could be an external calendar or clock that provides the day of week or time so that the system can assess, based on the Customer Inputs, whether a transfer should occur. A more complex example of an External Input could be a connection to the Customer's POS system, which could provide inputs such as daily sales or daily sales of certain products that could be used to determine whether a transfer should occur or the amount of a potential transfer.

The Main Bank computer system includes a First Tier Transfer Algorithm. The First Tier Transfer Algorithm incorporates some or all of the Customer Inputs, Bank Account Inputs and External Inputs to automatically (without manual Customer intervention) determine whether a funds transfer should occur and how much should be transferred for a given First Tier Account Connection. When the First Tier Transfer Algorithm determines that a transfer is required on a given Account Connection, it sends the required data about the accounts and the transfer to the Transfer Execution Mechanism.

The Main Bank computer system includes at least one and potentially up to hundreds of “nth Tier” Transfer Algorithms that incorporate some or all of the Customer Inputs, Bank Account Inputs and External Inputs to automatically (without manual Customer intervention) determine whether a funds transfer should occur and how much should be transferred for a given nth Tier Account Connection. When the nth Tier Transfer Algorithm determines that a transfer is required on a given Account Connection, it sends the required data about the Accounts and the transfer to the Transfer Execution Mechanism.

The Main Bank computer system includes a Transfer Execution Mechanism that takes the data from the plurality of Transfer Algorithms and causes the transfers to take place without requiring human intervention. Transfers may occur as wires, ACH or any other transfer technology that the Computer System can execute automatically.

The Main Bank computer system may include a Notification Mechanism that monitors the status of the transfers and/or the balance or transaction activity on the Bank Accounts and records to the database, displays in the User Interface and/or notifies the Customer of current status and status changes. One example of such a notification would be when the system sends a text message to the Customer notifying them that a given transfer for a given Account Connection has taken place.

The Main Bank computer system may include an Integrated Balance/Transaction Display as part of the User Interface. The Integrated Balance/Transaction Display combines together some or all of the balance or transaction information collected from the plurality of Local Bank Accounts and/or Main Bank Accounts. This display makes it easier for the Customer to see their complete Banking situation and to tag certain transactions, for example as reconciled. This display may also allow the Customer to export a combined list of transactions and/or balances from multiple Bank accounts across multiple Banks.

Various embodiments of the method and system may include Local Bank Accounts, Main Bank Operating Accounts and Main Bank Master Accounts held at the Local Bank, the Main Bank or, in some embodiments, at an Intermediate Bank, as shown, for example, in FIG. 2.

Referring to FIGS. 5A, 5B, 5C, 5D, 5E, 5F, 5G, 5H, 5I(1) and 5I(2), there is shown screen shots of a Main Bank computer system using the invention and illustrating the method and system of the invention. In this case, the Main Bank is Northern Bank of Massachusetts. Referring to FIG. 5A, there is shown a Customer login screen where the Customer enters its credentials to log in to the User Interface. FIG. 5B illustrates the User Interface account summary page. The Customer sees all of its tier 2 Operating Accounts and tier 3 Master Accounts at the Main Bank. Referring to FIG. 5C, there is shown another example of the User Interface with the Local Bank Customer login screen. The Customer enters its log in credentials to access the Local Bank in this instance, the Bank of America. FIG. 5D shows another example of the User Interface account summary page. The Customer sees all of their tier 2 Operating Accounts and tier 3 Master Accounts at Main Bank. FIG. 5E shows another example of the User Interface, in this instance, the Customer Input collection screen. Here the Customer supplies the Customer Inputs for a first tier transfer. FIG. 5F shows another User Interface display screen page showing the Integrated Balance/Transaction Display where the Customer may see a summary of its account information. FIGS. 5G and 5H further illustrate the Integrated Balance/Transaction Display. FIGS. 5I(1) and 5I(2) illustrate emails generated by the system advising the Customer of a funds transfer.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A method for automated bank funds transfers for a Customer having multiple Operations requiring multiple bank accounts at a Main Bank and one or more Local Banks, the method involving a Main Bank computer system having a User Interface for the Customer to log in to, the method comprising the steps of:
(a) the Customer logs in to the Main Bank computer system and the Customer's User Interface,
(b) the Customer provides Customer Inputs through the User Interface to be used by the computer system to automatically determine whether a transfer of funds should occur for a given Account Connection and/or to automatically determine the amount of said transfer of funds,
(c) the Main Bank computer system based on the Customer Inputs and an Account Integration Interface executes the required funds transfers automatically and in Real Time, wherein the transfer of funds is a first tier transfer of funds, and
(d) wherein the Customer may log in to the User Interface and see the Main Bank Operating Account information and transactions and the Local Bank Account information and transactions as they relate to each of the Customer's Operations through an Integrated Balance/Transaction Display.

2. The method according to claim 1 wherein the Main Bank computer system further includes a Bank Account Input Collection Mechanism to provide Bank Account Inputs to further determine whether a transfer of funds should occur for a given Account Connection and in what amount.

3. The method according to claim 2 wherein the Main Bank computer system further includes External Inputs to further determine whether a transfer of funds should occur for a given Account Connection and in what amount.

4. The method of claim 1 wherein the method further comprises a Notification Mechanism and the Customer is notified by Main Bank of the status of the funds in the one or more Local Bank Accounts and the one or more Main Bank Operating Accounts.

5. The method of claim 3 wherein the method further comprises a Notification Mechanism and the Customer is notified by Main Bank of the status of the funds in the one or more Local Bank Accounts and the one or more Main Bank Operating Accounts.

6. The method of claim 1 wherein the Customer has one or more Master Accounts and the method further comprises the steps of:
(e) the Customer provides Customer Inputs through the User Interface to direct the transfer of funds to or from the one or more Operating Accounts to or from the one or more Master Accounts,
(f) the Main Bank computer system based on the Customer Inputs automatically conducts a Real Time analysis of the Customer Inputs and determines whether a transfer of funds should occur between a given Master Account and a given Operating Account and the amount of the transfer, and
(g) the Main Bank computer system executes the transfers of funds determined to be necessary in step (f) in Real Time, wherein the transfer of funds is a nth tier transfer of funds.

7. The method of claim 3 wherein the Customer has one or more Master Accounts and the method further comprises the steps of:
(e) the Customer provides Customer Inputs through the User Interface to direct the transfer of funds from one or more Operating Accounts to the one or more Master Accounts,
(f) the Main Bank computer system based on the Customer Inputs automatically conducts a Real Time analysis of the Customer Inputs and determines whether a transfer of funds should occur for a given Master Account and a given Operating Account and the amount of the transfer, and
(g) the Main Bank computer system executes the transfers of funds determined to be necessary in step (f) in Real Time, wherein the transfer of funds is a nth tier transfer of funds.

8. The method of claim 7 wherein the method further comprises a Notification Mechanism and the Customer is notified by Main Bank of the status of the funds in the one or more Local Bank Accounts and the one or more Main Bank Operating Accounts and/or Master Accounts.

9. The method of claim 7 wherein the Bank Account Inputs used include updated balance or transaction details from Main Bank Accounts and/or Local Bank Accounts reflecting the results of nth tier transfers previously completed by the Main Bank computer system.

10. A method for automated bank funds transfers for a Customer having multiple Operations requiring multiple bank accounts at a Main Bank and one or more Local Banks, the method involving a Main Bank computer system having a User Interface for the Customer to log in to, the method comprising the steps of:
(a) the Customer logs in to the Main Bank computer system and the Customer's User Interface,
(b) the Customer provides Customer Inputs through the User Interface to direct the transfer of funds for the Customer's Operations between one or more Local Bank Accounts for each of the Customer's Operations and one or more Main Bank Operating Accounts for each of the Customers corresponding Operations,
(c) the Main Bank computer system based on the Customer Inputs and an Account Integration Interface through an Account Connection between the Main Bank and the Local Bank automatically transfers funds to or from each Local Bank Account for each Customer Operation to or from the corresponding Main Bank Operating Account for each corresponding Customer Operation, wherein the transfer of funds is completed in Real Time and is a first tier transfer of funds, and
(d) wherein the Customer may log in to the User Interface and see the Main Bank Operating Account information and transactions and the Local Bank Account information and transactions as they relate to each of the Customer's Operations through an Integrated Balance/Transaction Display.

11. The method according to claim 10 wherein the Main Bank computer system further includes a Bank Account Input Collection Mechanism to provide Bank Account Inputs to further direct the transfer of funds between the Local Bank Accounts and the Main Bank Operating Accounts.

12. The method according to claim 11 wherein the Main Bank computer system further includes External Inputs to further direct the transfer of funds between the Local Bank Accounts and Main Bank Operating Accounts.

13. The method of claim 10 wherein the method further comprises a Notification Mechanism and the Customer is notified by Main Bank of the status of the funds in the one or more Local Bank Accounts and the one or more Main Bank Operating Accounts.

14. The method of claim 12 wherein the method further comprises a Notification Mechanism and the Customer is notified by Main Bank of the status of the funds in the one or more Local Bank Accounts and the one or more Main Bank Operating Accounts.

15. The method of claim 10 wherein the Customer has one or more Master Accounts at Main Bank and the method further comprises the steps of:
(e) the Customer provides Customer Inputs through the User Interface to direct the transfer of funds to or from one or more Main Bank Operating Account to or from the one or more Main Bank Master Accounts, and
(f) the Main Bank computer system based on the Customer Inputs automatically transfers funds to or from the one or more Main Bank Operating Accounts to or from the one or more Main Bank Master Accounts wherein the transfer of funds is in Real Time and is a second tier transfer of funds.

16. The method claim 12 wherein the Customer has one or more Master Accounts at Main Bank and the method further comprises the steps of:
(e) the Customer provides Customer Inputs through the User Interface to direct the transfer of funds to or from the one or more Main Bank Operating Accounts to or from the one or more Main Bank Master Accounts, and
(f) the Main Bank computer system based on the Customer Inputs automatically transfers funds to or from the one or more Main Bank Operating Accounts to or from the one or more Main Bank Master Accounts wherein the transfer of funds is in Real Time and is a second tier transfer of funds.

17. The method of claim 16 wherein the method further comprises a Notification Mechanism and the Customer is notified by Main Bank of the status of the funds in the one or more Local Bank Accounts and the one or more Main Bank Operating Accounts.

18. The method of claim 10 wherein the Customer has one or more Operating Accounts or Master Accounts at Main Bank or another Bank and the method further comprises the steps of:
(e) the Customer provides Customer Inputs through the User Interface to direct the transfer of funds to or from the one or more Operating Accounts or the one or more Master Accounts to or from the one or more Operating Accounts or the one or more Master Accounts, and
(f) the Main Bank computer system based on the Customer Inputs automatically transfers funds to or from the one or more Operating Accounts or the one or more Master Accounts to or from the one or more Operating Accounts or the one or more Master Accounts, wherein the transfer of funds is in Real Time and is a nth tier transfer of funds.

19. The method of claim 12 wherein the Customer has one or more Operating Accounts or Master Accounts at Main Bank or another Bank and the method further comprises the steps of:
(e) the Customer provides Customer Inputs through the User Interface to direct the transfer of funds to or from the one or more Operating Accounts or the one or more Master Accounts to or from the one or more Operating Accounts or the one or more Master Accounts, and
(f) the Main Bank computer system based on the Customer Inputs automatically transfers funds to or from the one or more Operating Accounts or the one or more Master Accounts to or from the one or more Operating Accounts or the one or more Master Accounts, wherein the transfer of funds is in Real Time and is a nth tier transfer of funds.

20. A method for automated bank funds transfers for a Customer having multiple Operations requiring multiple bank accounts at a Main Bank and one or more Local Banks, the method involving a Main Bank computer system having a User Interface for the Customer to access, the method comprising the steps of:
(a) the Customer provides Customer Inputs through the User Interface to be used by the computer system to automatically determine whether a transfer of funds should occur for a given Account Connection and/or to automatically determine the amount of said transfer of funds, and
(b) the Main Bank computer system based on the Customer Inputs and an Account Integration Interface executes the required funds transfers automatically and in Real Time.
